(19) United States
(12) Patent Application Publication
(10) Pub. No.: US 2015/0138342 A1
(43) Pub. Date: May 21, 2015

(54) SYSTEM AND METHOD TO DETERMINE VISIBLE DAMAGE

(71) Applicant: United Technologies Corporation, Hartford, CT (US)

(72) Inventors: Christopher R. Brdar, Rocky Hill, CT (US); Patrick Hinckley, Ellington, CT (US); Brian London, Atascosa, TX (US); Larry R. Breen, Plantsville, CT (US); Anita Rebarchak, Wethersfield, CT (US); Alan Matthew Finn, Hebron, CT (US); Chelsea Barr, Ellington, CT (US); Roger Neama, Windsor, CT (US); Michael Li, South Windsor, CT (US)

(21) Appl. No.: 14/522,793

(22) Filed: Oct. 24, 2014

Related U.S. Application Data
(60) Provisional application No. 61/905,930, filed on Nov. 19, 2013.

(51) Int. Cl. G01B 11/28; G01N 21/88

(52) U.S. Cl. CPC G01B 11/285; G01N 21/8851; G01N 2201/06113; G01N 2201/12
USPC 348/128

(57) ABSTRACT

A method of calculating an amount of visible damage on a component includes capturing an image of the component, identifying an area of visible damage, calculating a size of the area, and communicating the size of visible damage to a storage device. A system for evaluating coating loss is also disclosed.

### CROSS-REFERENCE TO RELATED APPLICATION

This application claims priority to U.S. Provisional Application No. 61/905,930, filed Nov. 19, 2013.

### STATEMENT REGARDING FEDERALLY SPONSORED RESEARCH OR DEVELOPMENT

This invention was made with government support under Contract No. F-33657-99-D-2051 0027 awarded by the United States Air Force. The Government has certain rights in this invention.

### BACKGROUND OF THE INVENTION

This application relates to the use of image technology to calculate the amount of visible damage of a part or structure, e.g., the distress for the coating on a gas turbine engine component. While the exemplary embodiment is in reference to a gas turbine engine, it will be apparent to one of ordinary skill in the art that these teachings apply equally to visible damage in other mechanical devices, aircraft structures, civil structures such as bridges and roadways, etc.

Gas turbine engines are known and, typically, include a fan delivering air into a compressor. The air is compressed and delivered into a combustion section where it is mixed with fuel and ignited. Products of this combustion pass downstream over turbine rotors driving them to rotate.

The turbine sections and the compressor sections typically include rotors carrying blades having airfoils. There are typically several stages of such airfoils in each of the compressor and turbine sections. Intermediate the stages are static airfoils which are called vanes.

Many components in a gas turbine engine are provided with protective coatings. As an example, the turbine and exhaust components are subjected to very high temperatures and, thus, they often have a thermal coating to assist in resisting the high temperatures.

Over time and with use, these coatings can become distressed and erode, or otherwise are lost.

Routine maintenance requires calculation of the amount of lost coating on airfoils or structures. Historically, the amount of lost coating on the surface area of the airfoils has been calculated manually.

Image processing software is known in the prior art for calculating metric areas based upon photographic images given an a priori known perspective projection and fiducial marks to establish scale. However, no such system has been utilized to evaluate visible damage, e.g., coating loss, on airfoils, or parts or structures in general, because of the difficulty of establishing in practice the perspective projection and scale. While an area measurement in relative units is occasionally useful, a metric area is frequently required to quantify the area in absolute units for subsequent assessment.

### SUMMARY OF THE INVENTION

In a featured embodiment, a method of calculating an amount of visible damage on a component includes capturing an image of the component, identifying an area of visible damage, calculating a size of the area, and communicating the size of visible damage to a storage device.

In another embodiment according to the previous embodiment, the communication step is performed by a one of a hardwired and wireless connection between an image capture tool and the storage device.

In another embodiment according to any of the previous embodiments, capturing an image of the component is performed by an image capturing tool including a display and a camera.

In another embodiment according to any of the previous embodiments, lasers assist in providing a scale to the captured image.

In another embodiment according to any of the previous embodiments, the area of visible damage is contoured on the captured image.

In another embodiment according to any of the previous embodiments, a size of the contoured area is calculated.

In another embodiment according to any of the previous embodiments, the image capture tool includes a wireframe used to align the image capture tool with the component to be evaluated.

In another embodiment according to any of the previous embodiments, capturing an image of the component is performed by an image capturing tool including a display and a camera.

In another embodiment according to any of the previous embodiments, the image capture tool includes a wireframe used to align the image capture tool with the component to be evaluated.

In another embodiment according to any of the previous embodiments, lasers assist in providing a scale to the captured image.

In another embodiment according to any of the previous embodiments, the area of visible damage is contoured on the captured image.

In another embodiment according to any of the previous embodiments, a size of the contoured area is calculated.

In another embodiment according to any of the previous embodiments, the component is a gas turbine engine component.

In another embodiment according to any of the previous embodiments, the gas turbine engine component includes one of a blade, a vane, a panel, a flame holder, a lining, a tail cone, a duct, a cover, a heat shield, a flap.

In another embodiment according to any of the previous embodiments, the visible damage is damage to the thermal barrier coating on the gas turbine engine component.

In another featured embodiment, a system for evaluating coating loss includes an image capture device, which is capable of capturing an image of a component to be evaluated. The image capture device is capable of communicating with an analyzing unit capable of distinguishing a visible damage area from an visible undamaged area and calculating a size of the visible damage area.

In another embodiment according to the previous embodiment, the image capture device is provided with a camera for capturing the image, and lasers to assist in providing a scale to the captured image.

In another embodiment according to any of the previous embodiments, a location of projected laser points on the captured image is utilized to calculate the size of the visible damage on the captured image.

In another embodiment according to any of the previous embodiments, a change in the visible damage area is monitored over time.

In another embodiment according to any of the previous embodiments, there is a display and a wireframe on the image capture device that allows a user to align the image capture device with one of a component and a structure to be evaluated.

These and other features may be best understood from the following drawings and specification.

### BRIEF DESCRIPTION OF THE DRAWINGS

FIG. 1 shows a gas turbine engine component.

FIG. 2A shows a tool for evaluating the component.

FIG. 2B is a rear view of the tool.

FIG. 2C is another view of the tool.

FIG. 3A shows a first step.

FIG. 3B shows a subsequent step.

FIG. 3C shows another step.

FIG. 4 schematically shows an overall system.

### DETAILED DESCRIPTION

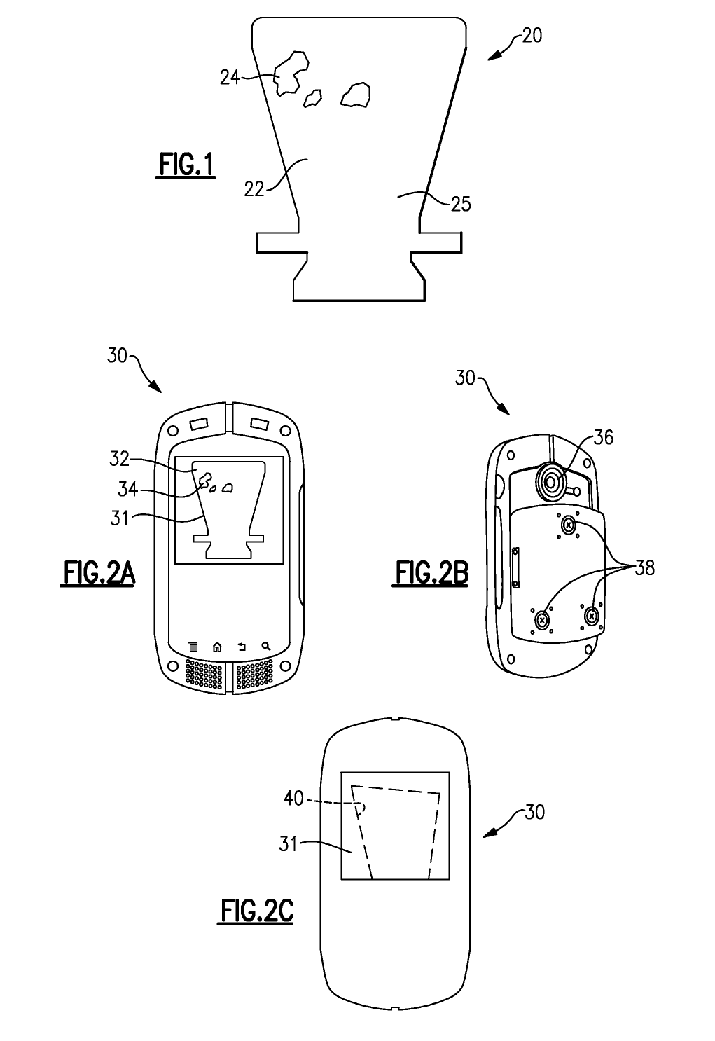

A gas turbine engine component 20, which may be a turbine blade, is shown in FIG. 1. In other embodiments, the turbine component 20 might be part of any other type of turbine, such as a steam turbine, or the component might be another part of a turbine such as a vane, lining, flame holder, flap, etc., or the component might be part of any machine or structure susceptible to visibly discernable damage. In the preferred embodiment, an airfoil 22 is formed as part of the component 20. As known, the airfoil 22 may be provided with a protective coating 25. As shown at 24, areas of this coating may become distressed and lost. It is a routine maintenance requirement to evaluate the amount of lost coating or damage to the coating as shown at 24. This area must be evaluated over time to determine a lifespan of the component 20.

A tool 30 for calculating the amount of visible damage is illustrated in FIG. 2A. An image 32 of the component is taken and displayed on a screen 31. An area of visible damage 34 will be readily apparent to any number of image processing software systems. As an example, the visible damage might be that coated areas of a part may be brighter in the visible spectrum than the areas where the coating has been compromised. It will be obvious to one of ordinary skill in the art that the damage may be visible in imaging devices, including cameras, lidars, sonars, and radars, sensitive to other parts of the electromagnetic or acoustic spectrum such as ultraviolet or infrared cameras. Area 34 corresponds to area 24.

FIG. 2B shows a rear view of the tool 30. In an embodiment, a visible spectrum camera 36 is utilized to capture the image 32 of the component.

One of more laser pointers 38 are disposed orthogonally to the camera to provide projected points on the part and visible in the image as will be shown below, such that the metric area of visible damage 34 can be calculated.

FIG. 2C shows a “wireframe” 40 which is included on the display 31. Preferably, a wireframe 40 is stored for each component that may be evaluated utilizing the tool 30. Thus, when initially capturing the image 32, a user will align the wireframe 40 such that it meets with the contours of the component 20 to be evaluated. In this manner, the user insures that the images are repeatedly captured at an a priori known perspective.

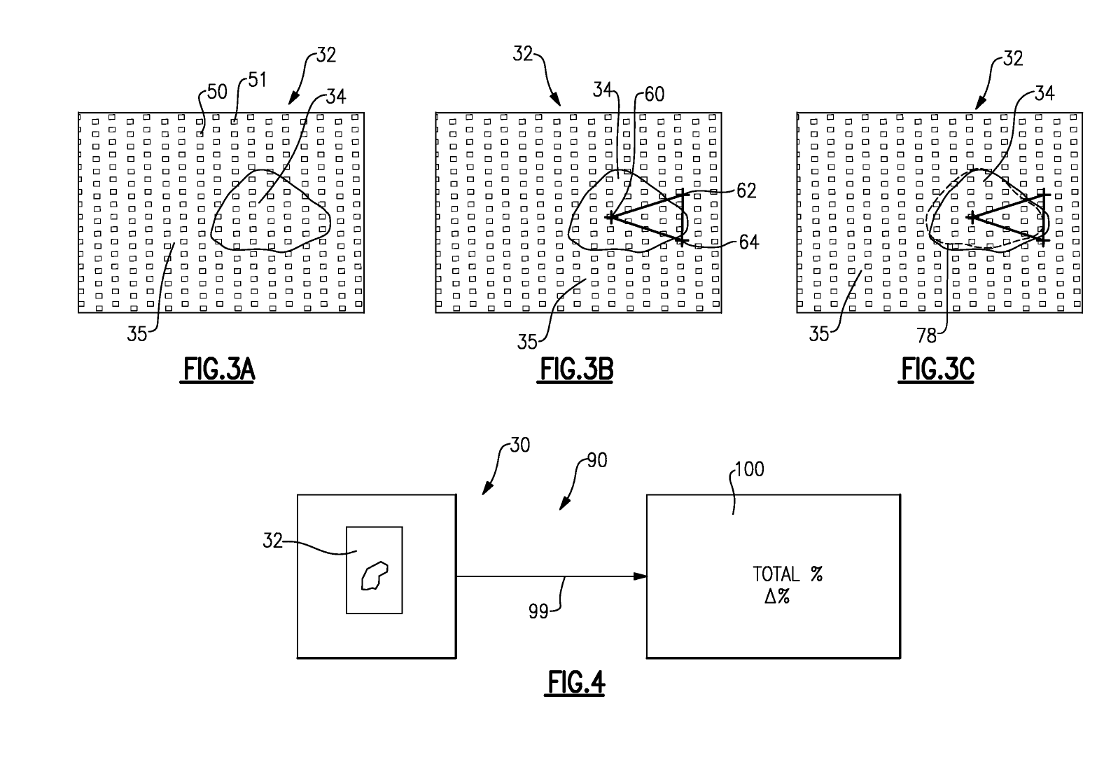

FIG. 3A shows a portion of a captured image 32. A defective area 34 is shown within an uncompromised area 35. The area 35 and, perhaps area 34 depending on the nature of the damage, may have visible non-damage features 51, 52 in regular patterns or irregularly spaced across the areas 34, 35.

Image analytic software can calculate the metric area of the visible damage 34 initially by establishing scale, such as evaluating the distance between some of the projected laser points, such as shown at 60, 62 and 64, between each other or from the origin of a reference coordinate system as shown in FIG. 3B.

Then, the entire area 34 can be contoured as shown at 78 and the overall area calculated, as shown in FIG. 3C.

While any number of mathematical techniques for contouring can be utilized, one particular technique is a geometric active contour, possibly with manual initialization. In another embodiment, level set methods are used. Since either embodiment produces a closed, simple, polygonal contour, the well-known product of adjacent point sums algorithm is used to compute the area (in pixels), see, e.g., “Ultra-Easy Polygon Area Algorithm with C Code Sample” by D. R. Finley. While the image could be rectified based on the wireframe or estimated pose, this rectification is unnecessary. The metric area is calculated from the area in pixels, the scale, and the trigonometric relations from the pose.

FIG. 4 shows a system 90 incorporating the tool 30 and a connection 99 to a processing unit and storage, such as a computer 100. In one embodiment, the connection 99 is hardwired. In another embodiment, the connection is wireless. The computer 100 will store a total amount of visible damage for a particular component, and will calculate the change in the amount of damage by well-known image registration techniques and will compare the newly detected damage to previous images and damage estimates.

Once a particular amount of damage has been detected, it may be necessary to replace the part or send it for repair.

The disclosed embodiments, thus, provide a system which evaluates visible damage, and in particular coating loss, in a very efficient manner compared to the prior art. Further, the accuracy of the overall measurement may be improved.

Although an embodiment of this invention has been disclosed, one of ordinary skill in this art would recognize that certain modifications would come within the scope of this invention. For that reason, the following claims should be studied to determine the true scope and content of this invention.

1. A method of calculating an amount of visible damage on a component comprising:
capturing an image of the component;
identifying an area of visible damage;
calculating a size of the area; and
communicating said size of visible damage to a storage device.

2. The method as set forth in claim 1, wherein said communication step is performed by a one of a hardwired and wireless connection between an image capture tool and said storage device.

3. The method as set forth in claim 2, wherein said capturing an image of the component is performed by an image capturing tool including a display and a camera.

4. The method as set forth in claim 3, wherein lasers assist in providing a scale to the captured image.

5. The method as set forth in claim 4, wherein said area of visible damage is contoured on the captured image.

6. The method as set forth in claim 5, wherein a size of the contoured area is calculated.

7. The method as set forth in claim 6, wherein said image capture tool includes a wireframe used to align the image capture tool with the component to be evaluated.

8. The method as set forth in claim 1, wherein said capturing an image of the component is performed by an image capturing tool including a display and a camera.

9. The method as set forth in claim 1, wherein said image capture tool includes a wireframe used to align the image capture tool with the component to be evaluated.

10. The method as set forth in claim 1, wherein lasers assist in providing a scale to the captured image.

11. The method as set forth in claim 1, wherein said area of visible damage is contoured on the captured image.

12. The method as set forth in claim 11, wherein a size of the contoured area is calculated.

13. The method as set forth in claim 1, wherein the component is a gas turbine engine component.

14. The method as set forth in claim 13, wherein the gas turbine engine component includes one of a blade, a vane, a panel, a flame holder, a lining, a tail cone, a duct, a cover, a heat shield, a flap.

15. The method as set forth in claim 14, wherein the visible damage is damage to the thermal barrier coating on said gas turbine engine component.

16. A system for evaluating coating loss comprising:
an image capture device, said image capture device being capable of capturing an image of a component to be evaluated; and
said image capture device capable of communication with an analyzing unit capable of distinguishing a visible damage area from an visible undamaged area and calculating a size of the visible damage area.

17. The system as set forth in clam 16, wherein said image capture device is provided with a camera for capturing said image, and lasers to assist in providing a scale to the captured image.

18. The system as set forth in claim 17, wherein a location of projected laser points on the captured image is utilized to calculate the size of said visible damage on said captured image.

19. The system as set forth in claim 16, wherein a change in the visible damage area is monitored over time.

20. The system as set forth in claim 16, wherein there is a display and a wireframe on said image capture device that allows a user to align the image capture device with one of a component and a structure to be evaluated.
